(19) United States
(12) Patent Application Publication
(10) Pub. No.: US 2007/0238077 A1
(43) Pub. Date: Oct. 11, 2007

(54) Interactive Reading Teaching Tool System

(76) Inventor: Edward Strachar, Eugene, OR (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/734,179

(22) Filed: Apr. 11, 2007

Related U.S. Application Data
(60) Provisional application No. 60/791,311, filed on Apr. 11, 2006.

(51) Int. Cl. G09B 17/00

(52) U.S. Cl. 434/178

(57) ABSTRACT

A computerized interactive teaching and learning tool system (10) is provided for interactive learning of techniques, particularly reading speed and comprehension. A main menu (12) includes a Reading Gym (18) and a Reading Theatre (20) along with other active zones (14). The active zones (14) allow the user to select various exercises, games and tests. The system (10) involves innovative and interactive methods of displaying text (86) in ways to expand the reading speed and comprehension of the user, while providing visual and audio background to enhance learning.

The following claims priority from a provisional patent application, Ser. No. 60/791,311, filed 11 Apr. 2006 to the same inventor.

### TECHNICAL FIELD

The present invention relates generally to education and more specifically to computerized interactive tools for learning, particularly adapted to reading.

### BACKGROUND ART

Few life skills are as valuable as effective reading techniques. The ability to rapidly and accurately assimilate the written word is invaluable in most professions. Similarly, the ability to quickly read with full comprehension provides greatly enhanced pleasure to anyone.

In the past, the written word was limited to static and two dimensional media. Books, magazines, newspapers and the like provided the source of nearly all reading material. Advances in technology have changed that in some ways, in that a very substantial amount of the written word in accessed online or onscreen, often in a streaming milieu where one must capture and comprehend the words before they disappear from sight.

Techniques for improving the reading skills of individuals have been developed over the years. The inventor himself, the founder of the READING GENIUS® system of seminars and teaching aids, has developed and improved many methods of improving reading speed and comprehension. Through tape and video lessons and printed materials, but particularly through live seminars, the speed and comprehension in reading has been drastically improved for thousands.

With developing technology, however, the ability to unlock additional teaching techniques has come available and online. The desire of many people to attend live events has decline with a corresponding interest in interactive (and personalized) computerized techniques. The ability to turn exercises and teaching methods into fun and entertaining games is a strong incentive to learning.

Accordingly, a continuing need exists to provide teaching tools to improve reading speed and comprehension skills.

### DISCLOSURE OF INVENTION

Accordingly, it is an object of the present invention to provide a computerized interactive learning tool specifically adapted to improve reading skills.

Another object of the invention is to provide a reading learning system which is readily customizable to the needs and level of each user.

A further object of the invention is to utilize subtle and subliminal tools to help improve a person's reading comprehension and speed.

Briefly, one preferred embodiment of the present invention is a computerized interactive teaching and learning tool system particularly adapted for use by those wishing to improve reading speed and comprehension. The system is divided into a Reading Gym, a Reading Theatre, a Game Zone and an Exam area, with additional minor features. The Reading Gym provides selected exercises adapted to stretch the mind and develop greater skills. The Reading Theatre provides a tailored environment for allowing the reader to assimilate information under utilizable conditions for speed and comprehension. The Game Zone provides a selection of entertaining games which can help to improve abilities and skills. The Exam Area provides a tool for testing progress. In most exercises and in the Reading Theatre a wide variety of library options are available, along with the ability to import additional reading material. Various tools are provided to optimize the experience and utility to the user, including color variants, background options, and music selection. The speed of presentation may also be tied to music tempo, enabling brain function to work with the music to increase speed with faster music delivery. Musical instrument modification is also available to fit the mood of the user and piece. The orientation of the text and displays may be altered to aid diverse learning techniques. Eye patterns are also adjustable. Automatic page turning may be activated in the Reading Theatre to allow the user to sit back and interact, rather than actively and manually turn pages. Manual page turning is made easier by allowing a mouse click anywhere on the page to activate a turn. A find function is provided in reading texts, as are bookmarks. In any timed or automatic progression function a pause option is provided, as it a start over option.

An advantage of the present invention is that it provides a nearly infinitely adjustable interactive tool for learning and enhancing reading skills.

Another advantage of the present invention is that it provides a learning tool which is customizable to and for the particular user, by the user himself/herself.

Still another advantage of the present invention is that the system includes both preset exercises and valuable research and reading materials.

A further advantage of the present invention is that subtle learning enhancement effects, such as variable tempo of music and adjustable colors are invoked.

Yet another advantage of the present invention is that it provides a wide library of literary and reference works with the capacity for user expansion of the library.

These and other objects and advantages of the present invention will become clear to those skilled in the art in view of the description of the best presently known modes of carrying out the invention and the industrial applicability of the preferred embodiments as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a screenshot of the Main Menu screen of the inventive program;

FIG. 2 is a screenshot of the Reading Gym menu screen of the inventive program;

FIG. 3 is a screenshot of the Visual Dimensions opening screen of the Reading Gym aspect of the inventive program;

FIG. 4 is a screenshot of the Exercise Console screen of the Reading Gym aspect of the inventive program, showing the appearance as it may appear during the Zoom-In or Page Flash operations;

FIG. 5 is a screenshot of the Exercise Console screen of the Reading Gym aspect of the inventive program, showing the appearance as it may appear during the Rainbow Recall operation with colored text;

FIG. 6 is a screenshot of the Eye Patterns opening screen of the Reading Gym aspect of the inventive program, showing the selectable emphasis patterns;

FIG. 7 is a screenshot of the Reading Theatre menu screen of the inventive program;

FIG. 8 is a screenshot of the Book Selection option under the Reading Theatre menu, showing the first several alphabetical selections in iconic form;

FIG. 9 is a screenshot of the Game Zone menu screen; and

FIG. 10 is a screenshot of the Exam Area screen.

### BEST MODE FOR CARRYING OUT THE INVENTION

A preferred embodiment of the present invention is a computerized interactive teaching and learning tool system. The user interface of the preferred embodiment of the system is shown in the several figures of the drawing and the overall system is designated by the general reference character 10.

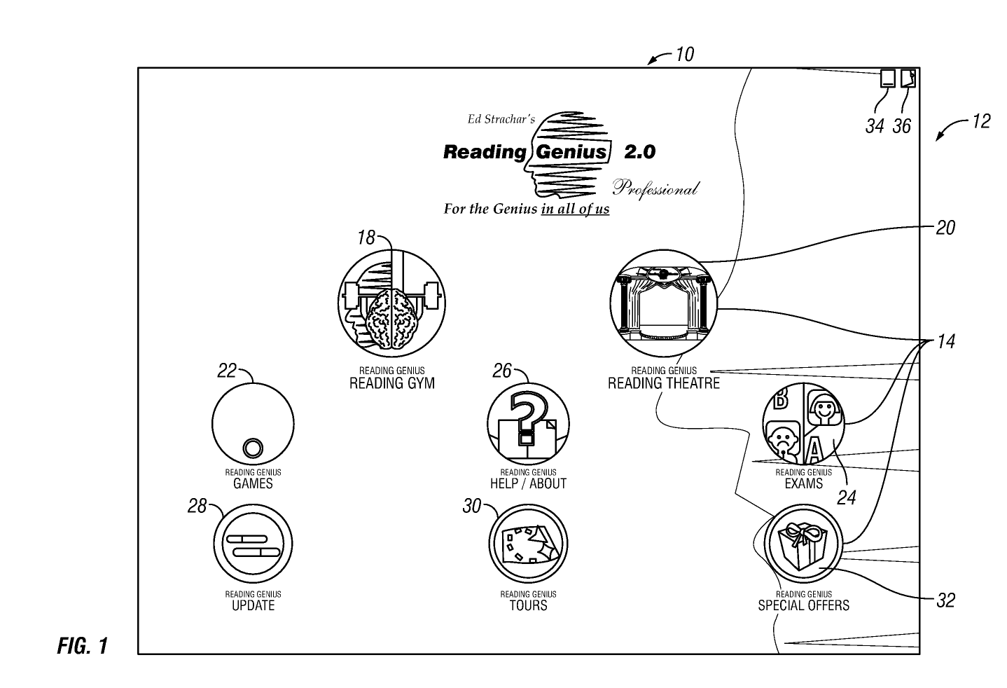

The illustration of FIG. 1 shows the Main Menu 12 screen. This is the user interface which appears when the system program 10 is activated. The Main Menu 12 shows a variety of active zones 14 (active controls), which reflect various functions which may be activated by a mouse click. A feature of the invention is that each active zone 14 on the screen is accompanied by a tooltip 16. The tooltip 16 appears when the mouse pointer is permitted to hover in the active zone for a few moments. The tooltip 16 will contain a verbal label of the active zone, often with some additional explanation.

The active zones 14 on the Main Menu 12 include a Reading Gym 18, a Reading Theatre 20, a Games zone 22 and Exam area 24. Each of these is discussed in more detail below in conjunction with the appropriate figure(s). The Main Menu also includes: a Help/About zone 26 which provides context sensitive help information and information on the publication and legal aspects of the program 10; an Updates zone 28 to access current software revisions online; a Tours zone 30 which allows a neophyte user to experience an interactive introduction to the features of the program 10; and a Special Offers zone 32 in which the user can access special programs and opportunities made available by Reading Genius, Inc.

Each screen of the user interface also includes, in the upper right hand corner, a minimize zone 34 which allows the user to minimize the program and access other programs running on the computer, and an exit zone 36 which, when clicked, allows the user to close the program 10 down completely.

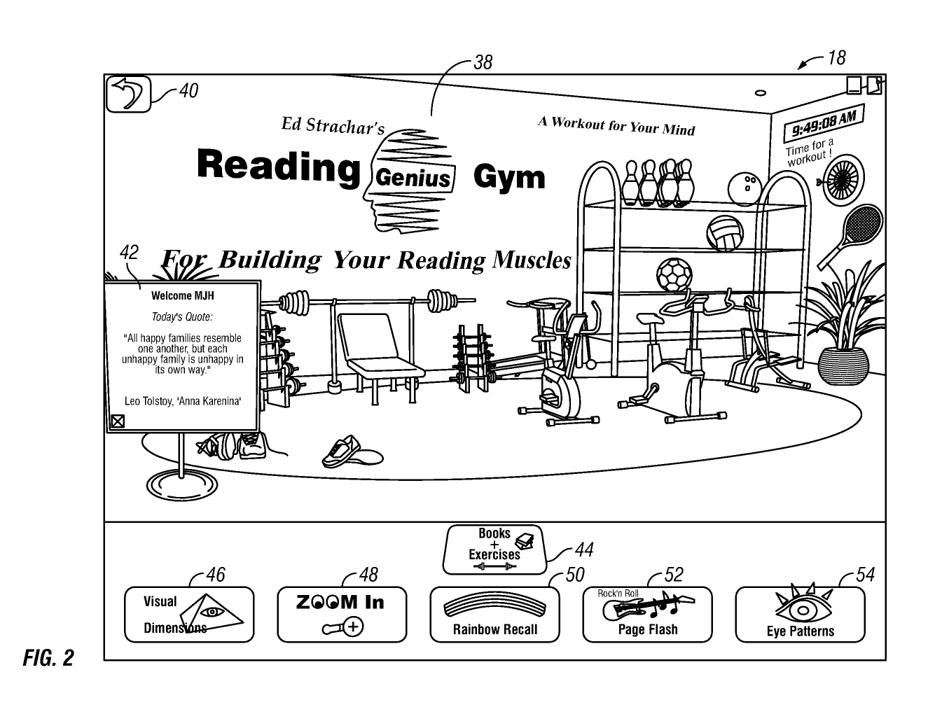

Turning now to FIG. 2 a screenshot is presented of the screen which appears when the Reading Gym zone 18 is activated. The Reading Gym 18 is “a workout for your mind” “for building your reading muscles” and provides access to tools for stretching the mind. This screen includes a pictorial background 38, also sometimes referred to as a skin 38. A variety of active zones 14 are laid out on the skin 38. One active zone 14 which appears on all of the screens other than the main Menu 12 is a Back/Return zone 40. Clicking on the Back/Return zone 40, situated at the upper left corner, returns the user to the prior screen (the screen higher on the hierarchical structure of the program 10). From the Reading Gym 18 (and nearly every other screen), the Back/Return zone sends the user back to the Main Menu screen 12.

A feature of the Reading Gym 18 is a quote 42. This pops up when the screen is activated and provides an informative and/or educational snippet, along with the source. The quote also includes a personal greeting to the user, who has entered an identifier during the setup of the program 10.

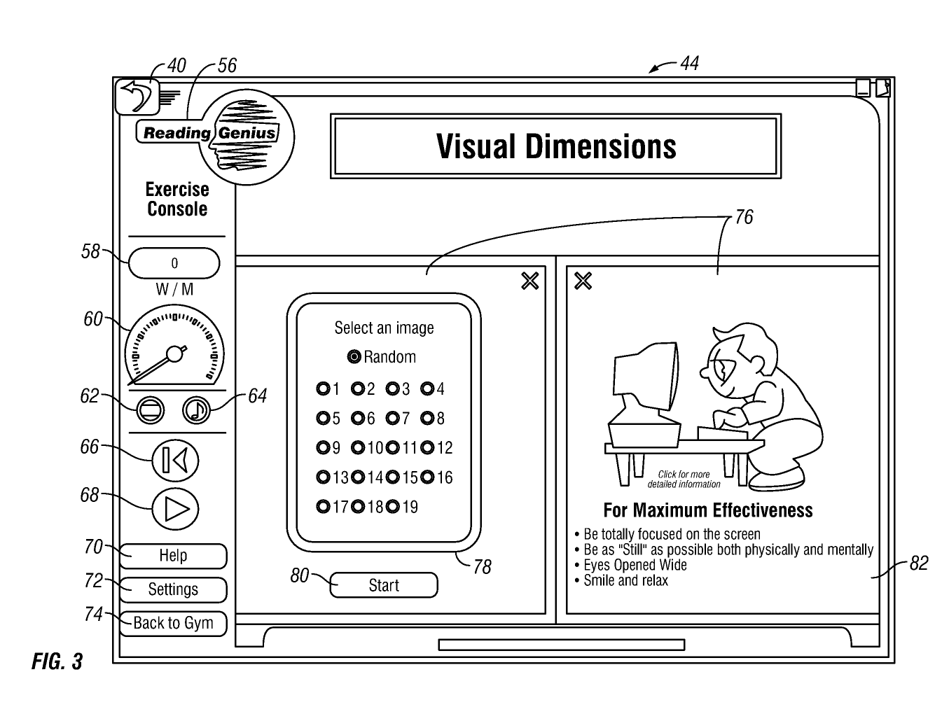

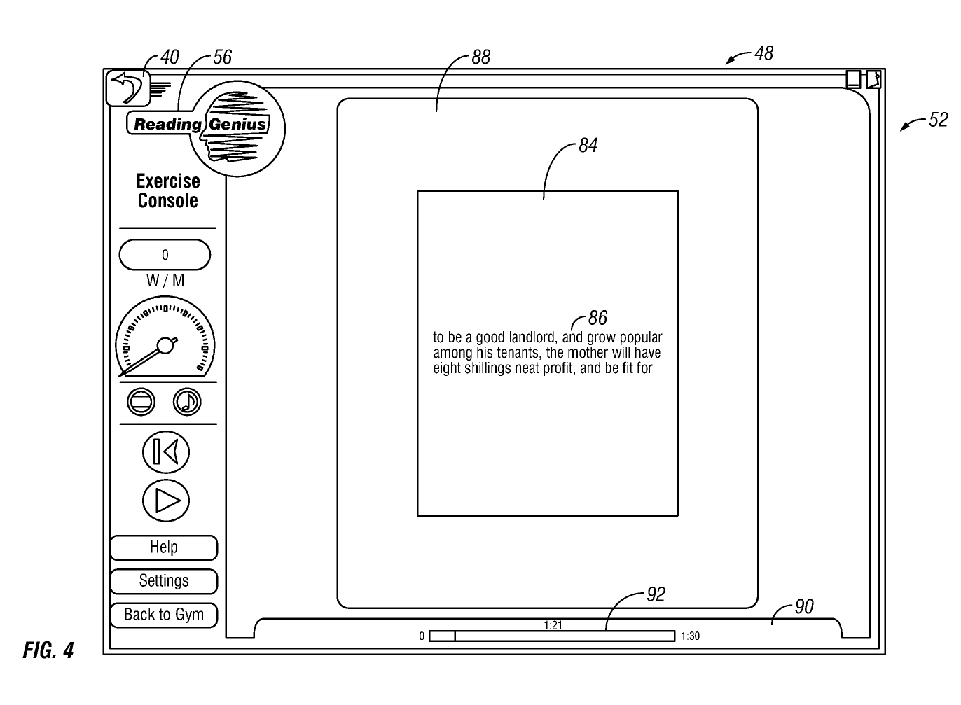

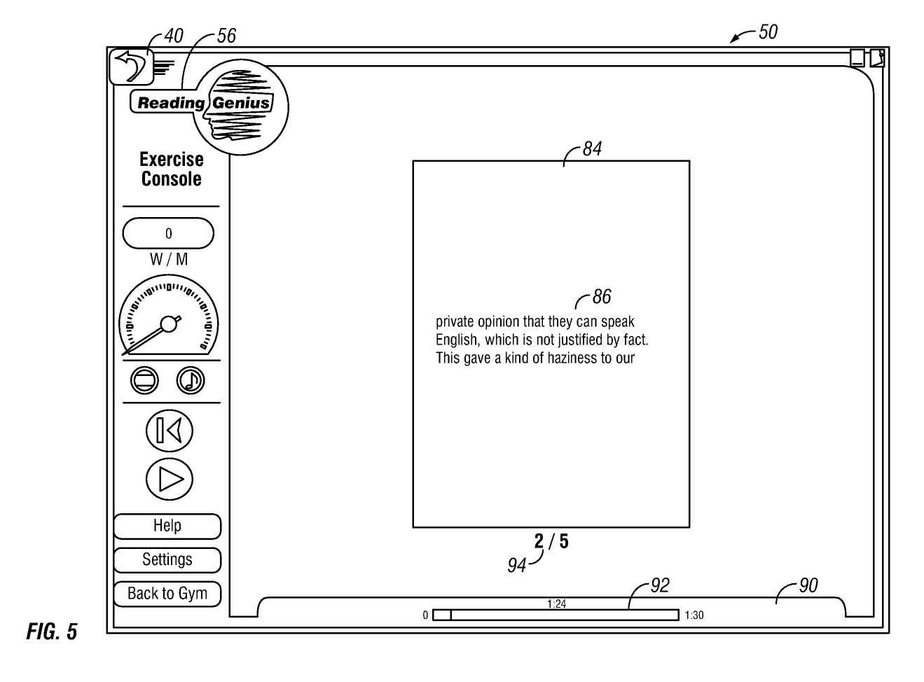

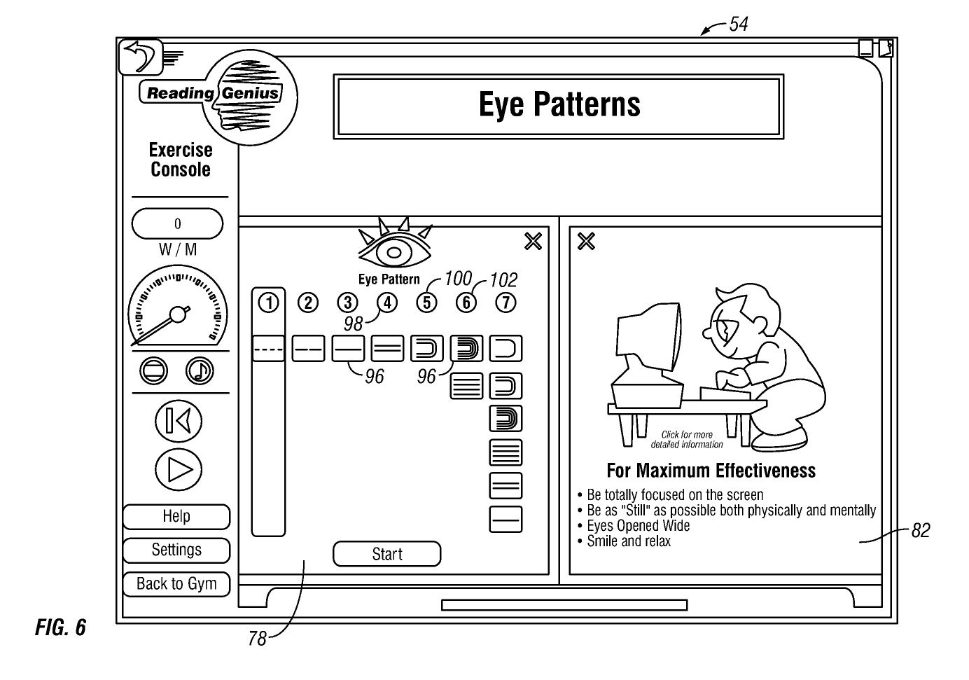

Along the bottom of the Reading Gym screen 18 is a series of active zones 14 which provide particular exercises to expand the mind and abilities of the user. A Books+Exercises zone 44 provides and overall entree to the exercises while a Visual Dimensions zone 46 (FIG. 3), a Zoom In zone 48 (FIG. 4), a Rainbow Recall zone 50 (FIG. 5), a Page Flash zone (52 (similar to FIG. 4) and an Eye Pattern zone 54 (FIG. 6) lead to access to specific exercises.

FIG. 3 is a screenshot of the opening screen in the Visual Dimensions 44 exercise. This screen illustrates the initial appearance of the exercise console 56, which is common to the various exercises. The exercise console 56 includes a number of indicators and buttons which are used to enhance the exercise experience. A words per minute indicator 58 provides a digital readout of the current speed of delivery of the reading material during the exercise. Similarly, a speedometer indicator 60 provides and analog representation of the same aspect. Since the screens are “paused” in order to capture the screenshots, the words per minute indicator 58 reads 0 and the speedometer is pegged at the bottom in the various figures.

Below the speedometer 60 is a change skin button 62 which allows the user to modify the screen background to one which suits the mood of the user. In this particular screen the net effect is to change the overall color of the screen. Similarly a change sound effects button 64 is provided to allow the user so select among nice, zany, cool, and no sound options. These buttons are typically used before the exercise begins.

Operations needed during the exercises are represented by a Restart button 66 and a Pause/Play button 68. The Restart button 66 sends the user back to the beginning of the particular exercise and the Start/Pause button 68 permits pausing of an active exercise or starting a new exercise or resuming a paused exercise. In the illustration of FIG. 3 the Play/Pause button 68 is shown with the play image since no active exercise is in progress. Were an exercise in progress a pair of vertical line segments would appear on the button 68 to indicate that clicking it would result in pausing the exercise.

At the bottom of the console 56 are a Help button 70, a Settings button 72 and a Back to Gym button 74. In the illustration of FIG. 3 a pair of Intro boxes 76 are displayed to introduce the user to the exercise. These include a Selections box 78, having a number of choices and a Start button 80 and a Help box 82 including tips for helping the user get the most out of the exercise. Should these not be on the screen (as between exercises) the user may recall the Help box 82 by clicking on the Help button 70 or recall the Selections box 78 by clicking on the Settings button. The content of the Help box 82 and the Selections box 78 may vary from exercise to exercise. A section of the Help Box 82 reads “Click for more information”. Clicking on this section, within a particular exercise, leads to display of specific information on the nature and purpose of that exercise. The Back to Gym button 74 returns the user to the Reading Gym screen (FIG. 2) while the Back/Return button 40 sends the program back to the Main Menu 12.

The actual content of the Visual Dimensions 44 exercise (not shown) is a series of “hidden picture” puzzles where a word or picture is embedded in an abstract pattern. The user learns to separate the image from the obscuring pattern.

Referring now to FIG. 4, a typical screenshot from the Zoom In exercise 48 is illustrated. The exercise console 56 appears again along the left side. This figure illustrates an exercise in progress where a page 84 having portion of text 86 appears on the screen for a limited time and then is replaced by another segment of text. The page 84 appears on a background tablet 88 which provides a border to the page 84. In the Zoom In exercise 48 the page and the accompanying text 86 dynamically expand from filling only a portion of the tablet 88 to completely filling the tablet 88 before a new page 84 and text 86 appear.

In the Page Flash exercise 52 (not specifically shown) there is no tablet 88, but only the page 84 and text 86. Otherwise the screen shot is very similar to that of FIG. 4. In the Page Flash exercise 52, the words and page are always the same size, but flash on screen in conjunction with sound effects (drum beats) at varying tempos.

The screens for these exercises include a countdown timer 90 at the bottom of the screen indication how much longer the exercise will run. Further, a time bar 92 is provided to graphically show how far into the exercise the user has progressed. In FIG. 4, the screenshot has been taken nine seconds into a one and one-half minute exercise, so 1:21 remains on the digital countdown timer 90.

Referring now to FIG. 5, a screenshot taken from the Rainbow Recall exercise 50 is shown. This exercise is similar to the Page Flash exercise 52 in that a page 84 with text 86 is flashed on the screen for a short period and then replaced by a sequentially subsequent page 84. In this exercise a Page Indicator 94 appears below the page to show the progress. This is in addition to the Countdown Timer 90 and the Time Bar 92. In the Rainbow Recall exercise 50 a limited series of pages (in the example illustrated the number of pages is five) is repeated several times, with variations in the color of the text 86 and in the color of the page 84 and the repetitions progress. It has been found that different areas of the brain are stimulated differently by different colors and contrast patterns so comprehension varies depending on the presentation. As shown in FIG. 5, the text 86 appears in red on a white page 84 but at various points in the exercise there may be purple text 86 on a black page 84 and many other combinations. Musical or percussion accompaniment enhances the progress and the speed may be adjusted to the skill level of the user.

FIG. 6 illustrates the opening screen of the Eye Patterns exercise 54. Of particular interest in this exercise is the Selections box 78 which includes a variety of options of highlight patterns 96. In this exercise the text 84 is presented as in an open book with facing pages and the reader is urged to assimilate the text 84 by reading it as it is highlighted by the program 10. The highlight patterns 96 include linear highlighting 98 (choices 1-4), simultaneous multi-line highlighting 100 (options 4-7) and wrap-around highlighting 102 (options 5-7). By urging the eyes to take in the words in different patterns, the assimilation and comprehension “muscles” are developed to improve the user's skills. The exercise also varies the speed of presentation and highlighting and accompanies the presentation with rhythmic aural stimulation.

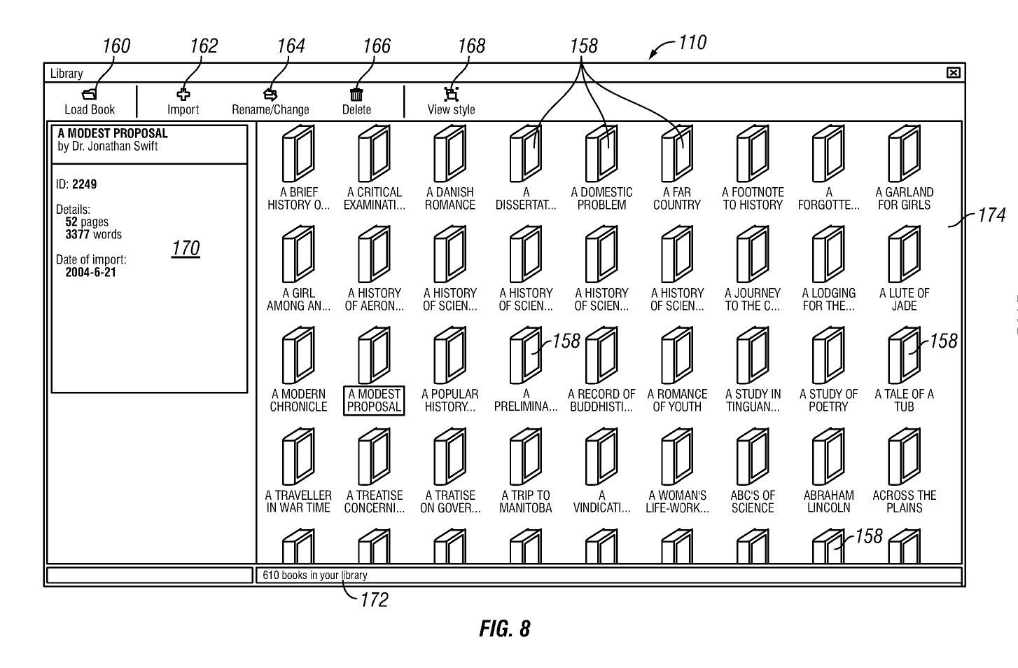

Each of the exercises 48, 50, 52 and 54 utilize actual passages selected from books in the Library (See FIG. 8). At the beginning or each exercise, the user is presented with a choice of ten or more books from which passages are used in the exercise. This allows exercises to be repeated many times with different passages so that the user does not get lazy and remember from prior efforts. Thus the exercises remain fresh and viable for an extended period of time.

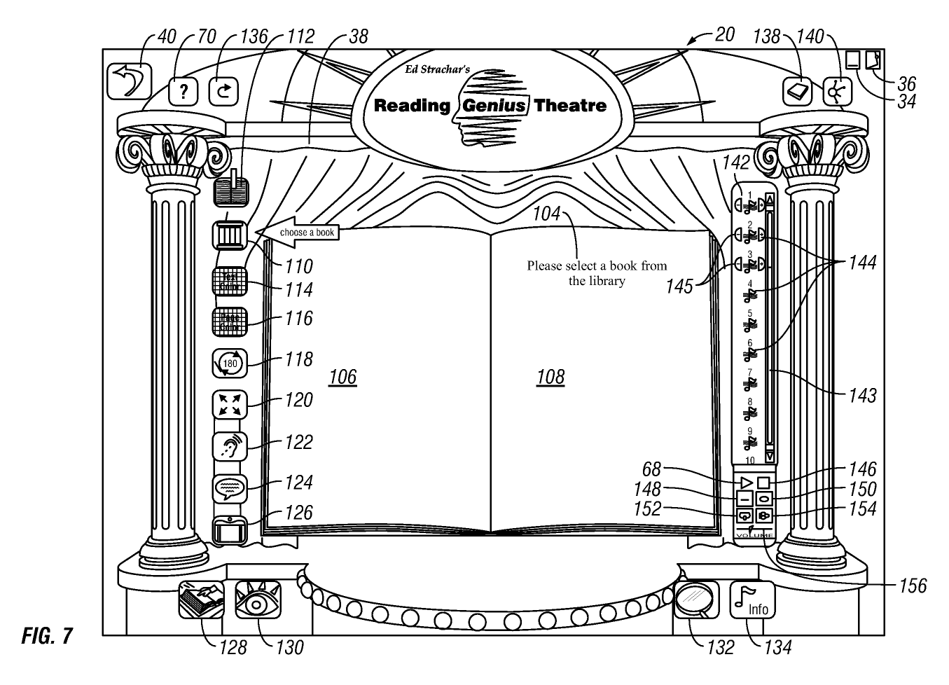

FIG. 7 illustrates the main screen of the second major sub-component of the system 10, the Reading Theatre 20. The Reading Theater 20 is an interactive format for allowing actual reading of desired materials under optimal conditions. Since it is intended to closely mirror reading a physical book, the central part of the screen is a book image 104, having a left page 106 and a right page 108.

Like the Reading Gym 18, the Reading Theatre 20 includes a background skin 38 and a large number of active controls 14. The skin 38 provides a desirable visual background (a theater stage background is shown in FIG. 7) while the various active zones 14 facilitate access to features and modification of the ambiance.

The first step in using the Reading Theater 20 is to choose a book from the Library 110 (See FIG. 8). Once a book is selected the text 84 appears on the book image 104 just as it would appear in a physical book, with blank pages falling where they would in the printed matter. A feature of the program 10 is that clicking anywhere on the right page 108 turns to the following two pages, while clicking on the left page 106 goes back to the prior set. The object is to mirror the effect of sitting with an actual physical book.

A column of active controls 14 extends down the left side of the book image 104. In addition to an icon for the Library 110, there are several other icons representing the features. One such is a bookmarks icon 112 which permits the user to insert a bookmark (actually one or more of each of three different colored bookmarks) at selected locations within the book being read. The program 10 remembers the location of the bookmarks and clicking on the bookmarks icon after inserting a mark shows the location of the marks and allows the user to select a mark and automatically return to the page where the mark was inserted.

Below the Library icon 110 are a text color icon 114 and a page color icon 116. Each of these opens a palette of two hundred forty color variants choices for either the color of the text 86 or the pages 84. The user can thus select the combination of colors and contrasts which best suit the mood or established optimal reading environment.

A Flip Orientation icon 118 permits the user to invert the book image 104 if it is desired to read inverted text (a good practice discipline) and a Expand/Contract icon 120 allows the user to expand the book image 104 to essentially fill the screen or to return it to its normal size. A Flip Sound icon 122 turns sound effects (such as a page turning sound bit) on or off while a Show Tool Tips icon 124 toggles the tool tip function (when the mouse cursor hovers over an active control for an interval, a tool tip 16 appears in text). A Select Background icon 126 allows the user to choose from a set of skins 38 for the screen.

Further icons are situated along the bottom and top of the screen. The lower icons include a Flip Mode icon 128. The default flip mode is manual, with page turning accomplished by clicking on the right page 108 when the reading of the page is complete. The Flip Mode icon 128 brings up a choice of going into automatic page turning operation where the program 10 turns the pages at a desired rate. The user can select the speed of page turning by adjusting a slider or by entering a number in a pages-per-minute field. In this way a reader can sit back and allow the computer to turn the pages without requiring any physical manipulation whatsoever.

An Eye Pattern icon 130 allows the user to invoke the eye pattern mechanism described above with respect to FIG. 6. The default setting is none, but it can be enabled and a highlight pattern 96 selected to have the text 86 sequentially highlighted at a rate selected by the user and with a particular highlight pattern selected by the user. Accompanying music and matching tempo mode can also be selected if desired. This will continue until de-activated. When an Eye Pattern mode is active, the pages will also automatically turn when the pattern for those pages has been completed.

A Search Mode icon 132 allows the user to select a particular page number in the book and automatically go to that page or, alternatively, to search for a particular word string and be ported to the location where that string appears.

A Music Info icon 134 provides information on the music currently selected, including the title and the duration, with a time indicator showing how many seconds have passes since the selection began.

The active controls 14 across the top off the screen include the Back/Return icon 40 and a Help icon 70 (depicted with a “?” symbol). A Default Settings icon 136 permits the user to, with a single click, restore all the feature settings to the default modes. A Close Book icon 138 allows the user to close the currently selected book and return to the select a book message shown in FIG. 7, while a Hide Everything icon 140 permits the user to hide all of the active controls 14 except the Hide Everything icon 140 (which now has a tool tip 16 of “Show Everything”) and the Minimize 34 and Exit 36 icons.

To the right of the Book Image 104 is a Music Control panel 142, which allows the user to select and control the effects of the musical accompaniment within the program 10. The control panel 142 includes a selection slider 143 along the right edge which allows the user to slide the display upward or downward to unveil additional musical piece icons 144, each of which represents at least one musical piece. Some piece icons 144 are Multi-Variant icons 145 representing the same piece in multiple variations (a tool tip 16 will appear identifying the number of variations of the particular piece. Speaker images to the side of the musical note denote a Multi-Variant piece icon 145. For example, Beethoven's Symphony Number 5 is presented in two variations and is represented by a Multi-Variant icon 145 while selections with only a single variant are more simply depicted. Clicking on any of the Piece icons will cause the program 10 to begin that piece.

The lower part of the sound control panel 142 includes a Play/Pause button 68 and a Stop button 146. A Single Play icon 148 represents the default setting and will stop the music once a piece has completed, a Repeat icon 150 activates repetitious playing of the selected piece while a Big Loop icon 152 cycles though all of the variants of a piece represented by Multi-Variant icon 145. A Random Play icon 154 allows the program to randomly select pieces in a random continuous play pattern. Finally a Volume Slider 156 allows the user to vary the volume signal delivered to the sound system of the computer.

All of the features of the Reading Theatre 20 are designed to enhance the reading experience and to maximize the speed and comprehension of material presented.

The illustration of FIG. 8 is one of the screenshots which may be caused to appear when the Library 110 is activated. This screen represents the mechanism by which the user selects a particular Book 158 to read in the Reading Theatre 20. The Library 110 is displayed to allow the user to select any of a large number of available items to read. Each Book 158 is represented by a Book Icon 159 with the first portion of the title underneath, in the mode selected and displayed in FIG. 8.

The Library 110 allows access to a great number of choices and provides details on each potential selection. It also allows the selection of Books 158 to be displayed in various formats. The mouse is used to roam around the Library and to select the particular book desired. The selected book can then either be loaded by double clicking on the icon 159 or by highlighting a selection and clicking on the Load Book 160 choice at the top of the screen.

The screen top choices also include Import 162 which allows the user to import a text file of any other “book” desired. A Rename/Change 164 selection permits changing the title of the book to a different choice. For example, the Library as presented and shown in FIG. 8 shows several books 158 with titles beginning with the article “A”. The user may wish to rearrange the listing by using the Rename/Change 164 option to drop articles from each title. When a user is done with a particular book or no longer wishes to have it in the Library 110, the Delete icon (trashcan) 166 is available.

The book icons 159 are displayed in FIG. 8 but the Library 100 may also be shown in list form or in other visual forms. Toggling among these visual presentations is facilitated by the View Style 168 active control. When a particular book 158 is highlighted, (as is A Modest Proposal in FIG. 8) information on the book is displayed in a Details Window 170 at the left side of the screen. In addition to information on the book itself, this window also displays whether there are bookmarks previously placed in the particular volume. Clicking on the bookmark color in the Details Window 170 results in the book opening at the bookmarked page.

A Book Count 172 display at the bottom of the screen indicates the total number of books present in the Library 110 while a Book Slider 174 along the right edge allows the user to access books later in alphabetical order. Changing the order may also be accomplished when a tabular display is selected using the View Style 168 option. In the tabular display mode the columns are entitled Title, Author's First Name, Author's Last Name, Number of Pages, Number of Words and Date (entered into the Library 110). Clicking on the column header of each of those columns will sort the entire table in either ascending or descending order based on the contents of that column.

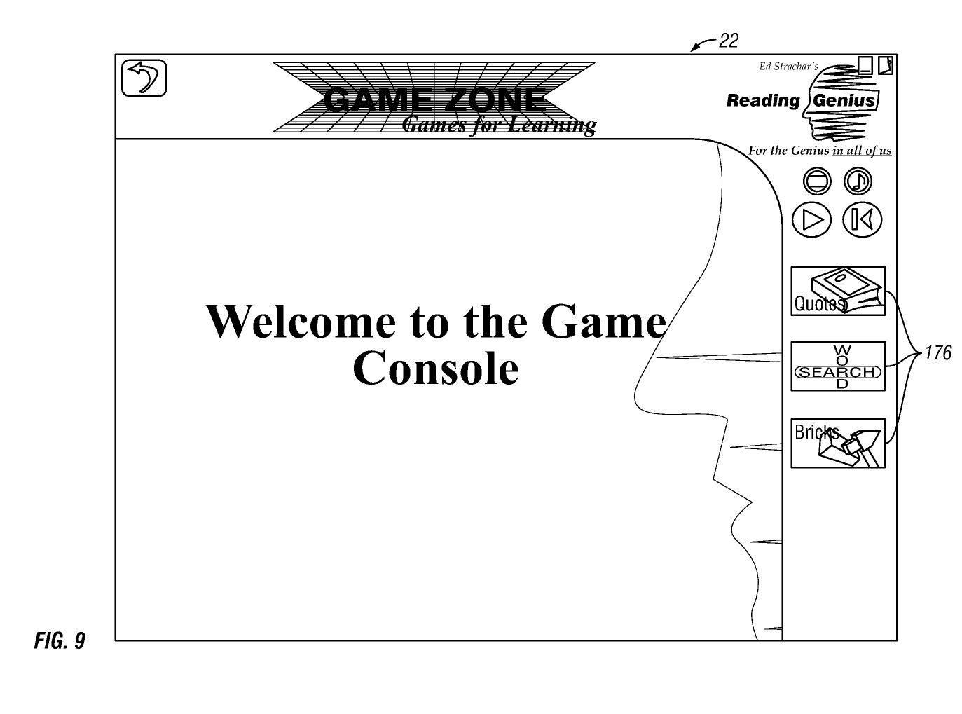

Referring now to FIG. 9, the Game Zone 22 opening screen is shown. The Game Zone 22 provides “Games for Learning” and uses well known games 176 as fun reading and learning tools. In the particular selection shown in FIG. 9 the games 176 available are Quotes, Word Search and Bricks. Active Controls 14 covering color and music selection are provided in this zone, as well.

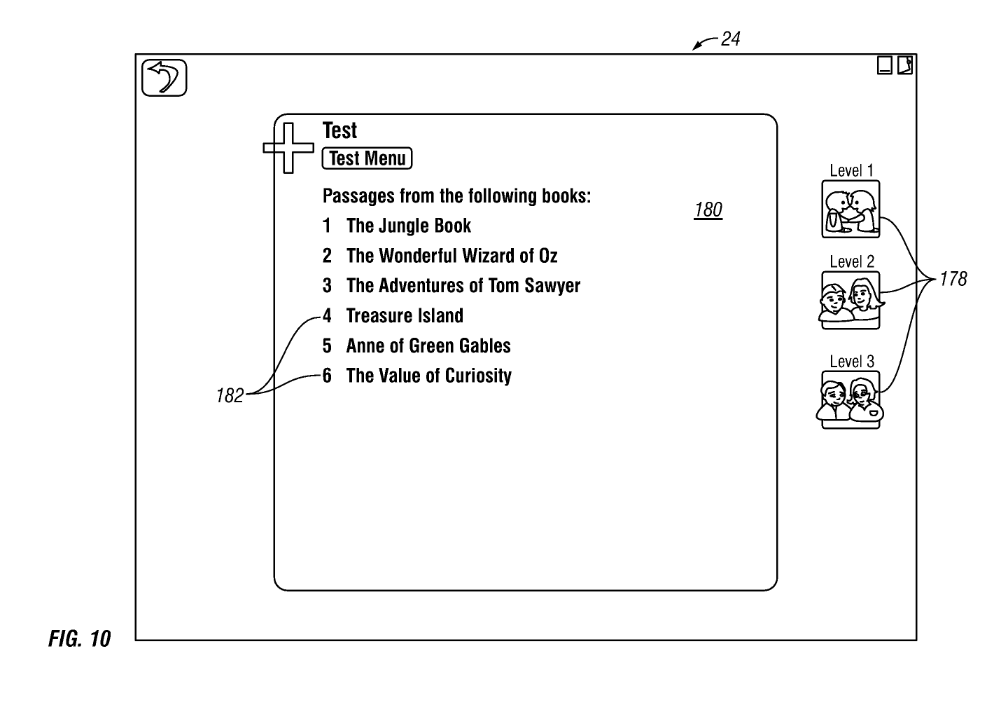

FIG. 10 shows Exam Area 24. This area permits the user to test their comprehension and speed and to provide a metric for learning. The user begins by selecting a Level Icon 178 based on their current learning level. The screen shown in FIG. 10 shows a Test Page 180 which appears as a result of clicking on the level 1 Level Icon 178. The Test Page displayed in FIG. 10 shows a list of potential Test Items 182 from which the user selects on for an examination exercise. In this instance, the user is provided with excerpts form a selected work and then is tested on speed of assimilation and comprehension of the content of that excerpt. A variety of Test Items 182 are provided to keep the exercises from becoming stale.

It is expected that various additional features and variations on the current features will be added over time. Thus the Updates feature (FIG. 1) may be periodically activated to import these updated components as they become available online.

Different layouts and arrangement of visuals are available, as are additional sound effects and musical selections. In addition, the techniques and methods of the program may be adapted for learning particular subjects and other types of skills which may be taught using the interactive components. As the choices of things to read and learn are effectively infinite, so are the possibilities with the inventive program system 10.

While various aspects and embodiments have been described above, it should be understood that they have been presented by way of example only, and not as limitations.

### INDUSTRIAL APPLICABILITY

The present invention is adapted for use in circumstances where a user desires to improve his or her reading and comprehension skills. The user purchases, installs and activates the program 10 and arrives at the Main Menu screen 12 of FIG. 1. Ordinarily, a new user will use the Tours 30 option to learn about the program features.

Once introduced to the program 10 (or as an experienced user), the user accesses the Main Menu 12 and selects whether they wish to expand their abilities and skills by doing exercises in the Reading Gym 18, play relaxing (and deceptively educational) games in the Game Zone 22, test their progress in the Exam Area 24 or simply enjoy a relaxing reading event in the Reading Theatre 20. The user will then click the relevant Active Control 14 and proceed to use the feature as shown in described above.

The program 10 permits the user to proceed at their own pace and to select appropriate level challenges for their own progress. Relaxing, motivational or brain-driving sound effects and musical accompaniment are provided by the program 10, again as selected to suit the user.

The user is provided with a large and varied Library 110 with the program 10 and has the ability to expand and modify the contents as desired. Periodic updates, patches and improvements are also provided online in order to enhance the experience.

For the above, and other, reasons, it is expected that the interactive reading learning system 10 of the present invention will have widespread industrial applicability. Therefore, it is expected that the commercial utility of the present invention will be extensive and long lasting.

### CORRESPONDENCE CHART

### TELEPHONE NUMBER ACTIVATED MENU SYSTEM

### Ed Strachar

### 60509.3001.01

This correspondence chart is provided for ease of understanding ormational purposes only, and does not constitute a part of the formal patent ication.

| RefNum [symbol] | Description | Group |
|---|---|---|
| 10 | Interactive Reading Teaching Tool | |
| 12 | Main Menu | |
| 14 | Active Zone | |
| 16 | Tool tip | |
| 18 | Reading Gym | |
| 20 | Reading Theatre | |
| 22 | Game Zone | |
| 24 | Exam Area | |
| 26 | Help/About | |
| 28 | Updates | |
| 30 | Tours | |
| 32 | Special Offers | |
| 34 | Minimize | |
| 36 | Exit | |
| 38 | Background | |
| 40 | Back/Return | |
| 42 | Quote | |
| 44 | Books + Exercises | |
| 46 | Visual Dimensions | |
| 48 | Zoom In | |
| 50 | Rainbow Recall | |
| 52 | Page Flash | |
| 54 | Eye Patterns | |
| 56 | Exercise Console | |
| 58 | Word per Minute | |
| 60 | Speedometer | |
| 62 | Change Skin | |
| 64 | Change Sound Effects | |
| 66 | Restart | |
| 68 | Play/Pause | |
| 70 | Help button | |
| 72 | Settings | |
| 74 | Back to Gym | |
| 76 | Intro Boxes | |
| 78 | Selections box | |
| 80 | Start Button | |
| 82 | Help box | |
| 84 | Page | |
| 86 | Text | |
| 88 | Tablet | |
| 90 | Countdown Timer | |
| 92 | Time Bar | |
| 94 | Page Indicator | |
| 96 | Highlight Patterns | |
| 98 | Linear Highlighting | |
| 100 | Multi-Line Highlighting | |
| 102 | Wrap-Around HLight | |
| 104 | Book Display | |
| 106 | Left page | |
| 108 | Right Page | |
| 110 | Library | |
| 112 | Bookmarks icon | |
| 114 | Text Color | |
| 116 | Page Color | |
| 118 | Flip Orientation | |
| 120 | Expand/Contract | |
| 122 | Flip Sound | |
| 124 | Show Tool tips | |
| 126 | Select Background icon | |
| 128 | Flip Mode | |
| 130 | Eye Pattern Mode | |
| 132 | Search Mode | |
| 134 | Music Information | |
| 136 | Default Settings | |
| 138 | Close Book | |
| 140 | Hide Everything | |
| 142 | Music Control Panel | |
| 143 | Selection Slider | |
| 144 | Piece icon | |
| 145 | Multi-Variant | |
| 146 | Stop button | |
| 148 | Single Play | |
| 150 | Repeat | |
| 152 | Big Loop | |
| 154 | Random Play | |
| 156 | Volume Slider | |
| 158 | Book | |
| 159 | Book Icon | |
| 160 | Load Book | |
| 162 | Import | |
| 164 | Rename/Change | |
| 166 | Delete | |
| 168 | View Style | |
| 170 | Details window | |
| 172 | Book Count | |
| 174 | Book Slider | |
| 176 | Game icon | |
| 178 | Level icon | |
| 180 | Test page | |
| 182 | Test items | |

1. A computerized interactive teaching and learning tool system, comprising;
a Main Menu providing a selection of training and enjoyment options including a Reading Gym providing exercises and a Reading Theatre providing reading experience options; wherein
each reading experience option and exercise includes ambience selections modifiable by the user in order to optimize the experience.

2. A computerized interactive reading theatre program, comprising
a selectable background skin providing a pleasant milieu for reading enjoyment and comprehension;
a Library including a plurality of selectable works to be read;
a Book Display where a selected on of said works is displayed on screen against said background skin; and
a plurality of environmental enhancement options available to modify both the visual and aural aspects of the reading experience.

3. A computerized interactive reading and comprehension training system, comprising
a Reading Gym module providing interactive exercises involving text display on a display screen, said text being selectable from a library of text selections.

4. The computerized interactive reading and comprehension training system of claim 3, wherein
said interactive exercises include controls for modifying the color of the text and background of said text display.

5. The computerized interactive reading and comprehension training system of claim 3, wherein
said interactive exercises include controls for modifying the speed of presentation of said text display.

6. The computerized interactive reading and comprehension training system of claim 3, wherein
said interactive exercises include controls for modifying the pattern of highlighting of said text display.

7. The computerized interactive reading and comprehension training system of claim 3, wherein
said interactive exercises include controls for providing adjustable music and rhythm accompaniment to said text display.

8. The computerized interactive reading and comprehension training system of claim 3, and further including
controls for modifying the visual dimensions of said text display in a dynamic manner.

9. The computerized interactive reading and comprehension training system of claim 3, and further including
puzzle modules for embedding text images within visual backgrounds in order to encourage the user to expand brain activity to distinguish meaningful input from visual noise.

10. The computerized interactive teaching and learning tool system of claim 1, wherein
said Reading Gym includes a series of customizable exercises for presenting text having one or more of the following characteristics: on a variety of backgrounds; in varying colors; in varying speeds of presentation; and with varying forms of highlighting.

11. The computerized interactive teaching and learning tool system of claim 1, wherein
said Reading Gym includes a module for dynamically varying the size of text presented.

12. The computerized interactive teaching and learning tool system of claim 1, wherein
said Reading Gym includes a module for flashing text on a page at varying rates.

13. The computerized interactive teaching and learning tool system of claim 1, wherein
said Reading Gym includes a module for highlighting portions of text in preselected manners with dynamic variance of the positioning of said highlighting.

14. The computerized interactive teaching and learning tool system of claim 1, wherein
said Reading Gym includes means for providing audio accompaniment to text presentation.

15. The computerized interactive reading theatre program of claim 2, wherein
said Library contains a plurality of text files to which additional text files may be added.

16. The computerized interactive reading theatre program of claim 2, wherein
said Book Display is in the form of a Reading Theatre wherein text is displayed in the same manner as if appearing in a conventional book.

17. The computerized interactive reading theatre program of claim 16, and further including
active controls for turning pages of said works manually or in preset time intervals.

18. The computerized interactive reading theatre program of claim 16, wherein
the color of the text of said works and the color of the background upon which said text is displayed is selectable by the user.

19. The computerized interactive reading theatre program of claim 16, wherein
user selectable musical accompaniment is provided, with the user being able to control content, volume and repetition.

20. The computerized interactive reading theatre program of claim 16, wherein
Said works may be displayed in varying orientations.
